(19) United States
(12) Patent Application Publication
(10) Pub. No.: US 2020/0366815 A1
(43) Pub. Date: Nov. 19, 2020

(54) ENVIRONMENT ACQUISITION SYSTEM

(71) Applicant: KAWASAKI JUKOGYO KABUSHIKI KAISHA, Kobe-shi, Hyogo (JP)

(72) Inventor: Hitoshi HASUNUMA, Kobe-shi (JP)

(73) Assignee: KAWASAKI JUKOGYO KABUSHIKI KAISHA, Kobe-shi, Hyogo (JP)

(21) Appl. No.: 16/762,775

(22) PCT Filed: Nov. 5, 2018
(86) PCT No.: PCT/JP2018/041059

§ 371 Date: May 8, 2020

(30) Foreign Application Priority Data
Nov. 8, 2017 (JP) 2017-215253

(51) Int. Cl. H04N 5/225; G06T 7/579; G06T 7/73

(52) U.S. Cl. CPC H04N 5/2252; H04N 5/2253; G06T 7/74; H04N 5/225251; G06T 7/579; H04N 5/2257

(57) ABSTRACT

An environment acquisition system includes a housing, a visual sensor, and a data processor. The visual sensor is accommodated in the housing and is capable of acquiring environmental information about environment of outside of the housing repeatedly. The data processor performs an estimation process of a position and a posture of the visual sensor and a generating process of an external environment three-dimensional data based on the environmental information acquired by the visual sensor or information obtained from the environmental information. In a state where a posture of the housing is not controlled and the housing is not in contact with ground and is not mechanically restrained from outside, the visual sensor can acquire the environmental information.

### TECHNICAL FIELD

The present invention relates mainly to configuration of environment acquisition system.

### BACKGROUND ART

Conventionally, a configuration in which a camera and/or a sensor is attached to a robot, and the camera and/or the sensor is used to acquire position information of the robot is known. Patent Documents 1 to 3 disclose such a configuration.

Patent Document 1 discloses a robotic system comprising: a robot arm; a camera attached at or near an end of the robot arm; and a robot controller which corrects a position of the robot arm based on position information of a work object or the like obtained from image data acquired by imaging. In this configuration, the robot controller performs position correction of the robot arm based on the position information. This improves operation accuracy, such as holding by the robot arm.

Patent Document 2 discloses a position identification system for a mobile device comprising: a moving carriage; a camera mounted on the moving carriage side; and a plurality of light-emitting target markers disposed at predetermined positions and emitting light only in response to a unique light emission request signal transmitted from the moving carriage. In this configuration, the locations of all target markers and the light-emitting request signals of the moving carriage are related in advance. At least two positions of target markers in area are identified by the camera. Then, the self-position is calculated based on the orientation of the camera and the coordinates of the markers in the image captured.

Patent Document 3 discloses an autonomous mobile robot comprising: a three-dimensional measuring sensor capable of measuring a distance to object in a three-dimensional manner; a self-position estimation sensor capable of measuring a self-position; and an arithmetic device including a map generator. In this configuration, the robot is moved in a moving environment to measure the distance from the robot to surrounding objects by the three-dimensional measuring sensor, and the moving environment is scanned by the self-position estimation sensor. The data of the environmental map is generated from the scanned data.

### PRIOR-ART DOCUMENTS

### Patent Documents

Patent Document 1: Japanese Patent Application Laid-Open No. 2017-b 132002

Patent Document 2: Japanese Patent Application Laid-Open No. 2005-3445

Patent Document 3: Japanese Patent Application Laid-Open No. 2016-149090

### SUMMARY OF THE INVENTION

### Problems to be Solved by the Invention

However, in the configuration of Patent Document 1, a space is required for attaching the camera at or near an end of the robot arm or the like. Therefore, if the mounting space is insufficient, the configuration cannot be used.

In the configuration of Patent Document 2, it is required to prepare a plurality of markers in advance and place them at predetermined positions in order to obtain the position of the moving carriage. Therefore, it takes time and effort to prepare it for use, and it is difficult to say that it is convenient.

In the configuration of Patent Document 3, a plurality of cameras and/or sensors are used. As a result, the manufacturing cost is expensive.

The present invention is made in view of the circumstances described above, and an object of the present invention is to make preparation work simple and to enable a three-dimensional data of external environment to be acquired agilely and flexibly.

### Means for Solving the Problems

The problem to be solved by the present invention is as described above, and next, means for solving the problem and effects thereof will be described.

According to a first point of view of the present invention, an environment acquisition system of the following configuration is provided. The environment acquisition system comprises a housing, a visual sensor, and a data processor. The visual sensor is accommodated in the housing. The visual sensor can repeatedly acquire environmental information about environment of outside of the housing. The data processor performs an estimation process of a position and a posture of the visual sensor and a generating process of an external environment three-dimensional data. These processes are performed based on the environmental information acquired by the visual sensor or information obtained from the environmental information. In a state where a posture of the housing is not controlled and the housing is not in contact with ground and is not mechanically restrained from outside, the visual sensor can acquire the environmental information.

According to a second point of view of the present invention, an environment acquisition method of the following is provided. The environment acquisition method comprises an environmental information acquisition step and a data processing step. In the environmental information acquisition step, a sensing device comprising a housing and a visual sensor is used to cause the visual sensor to acquire environmental information in a state where a posture of the housing is not controlled and the housing is not in contact with ground and is not mechanically restrained from outside. The visual sensor is accommodated in the housing. The visual sensor can repeatedly acquire the environmental information about environment of outside of the housing. In the data processing step, a position and a posture of the visual sensor are estimated and an external environment three-dimensional data is generated. These are performed based on the environmental information acquired in the environmental information acquisition step or information obtained from the environmental information.

Thereby, it is possible to easily acquire the external environment three-dimensional data without complicated preparation work. In addition, the environmental information can be acquired with a highly flexible viewpoint. Therefore, it is possible to suppress lack of the external environment three-dimensional data due to blind spots.

### Effects of the Invention

According to the environment acquisition system and the environment acquisition method of the present invention, preparation work can be simple, and the three-dimensional data of external environment can be acquired agilely and flexibly.

### BRIEF DESCRIPTION OF THE DRAWINGS

FIG. 1 is an external view showing overall of a configuration of an environment acquisition system according to an embodiment of the present inventions.

FIG. 2 is a cross-sectional view of a sensing device provided with the environment acquisition system.

FIG. 3 is a block diagram showing an electrical configuration of the environment acquisition system. FIG. 4 is a diagram showing an example of the use of the environment acquisition system.

FIG. 5 is a diagram showing another example of use of the environment acquisition system.

### EMBODIMENT FOR CARRYING OUT THE INVENTION

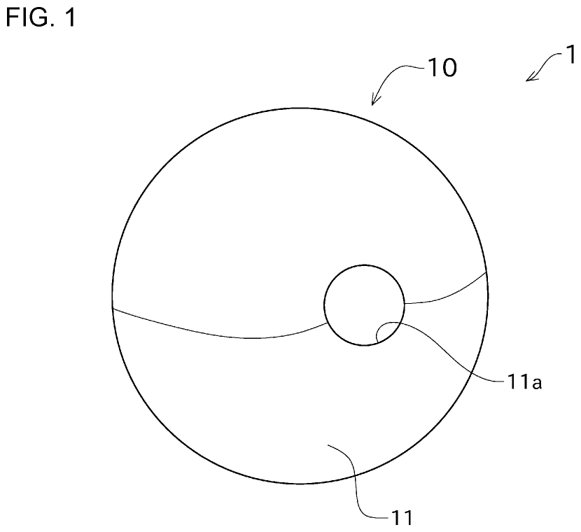

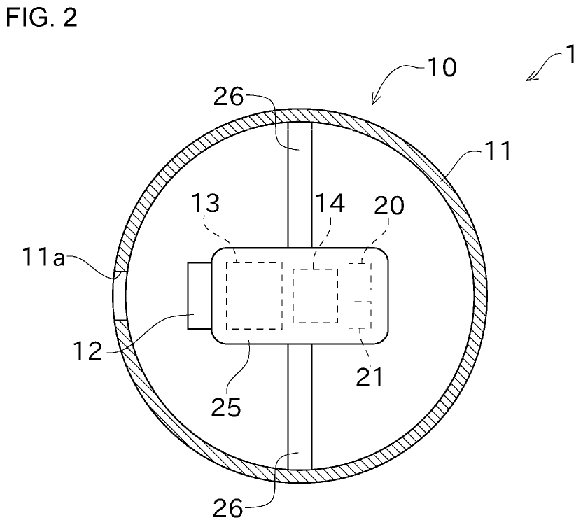

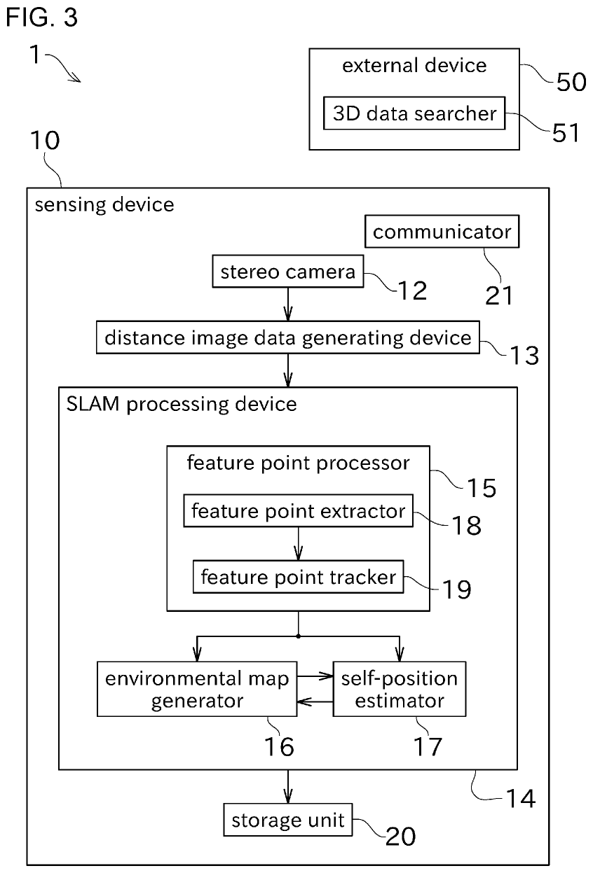

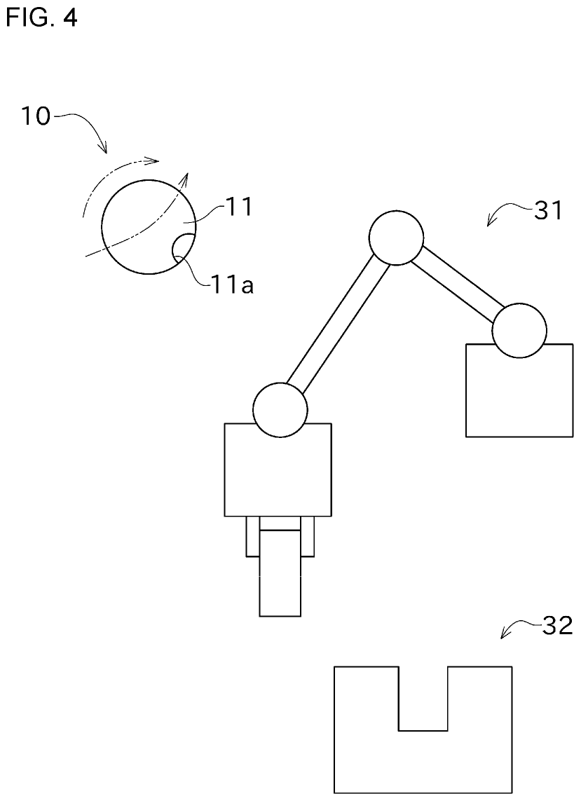

Next, embodiments of the present invention will be described with reference to the drawings. FIG. 1 is an external view showing overall of a configuration of an environment acquisition system 1 according to an embodiment of the present inventions. FIG. 2 is a cross-sectional view of a sensing device 10 provided with the environment acquisition system 1. FIG. 3 is a block diagram showing an electrical configuration of the environment acquisition system 1.

The environment acquisition system 1, as shown in FIG. 1, comprises a sensing device 10. The sensing device 10 includes a housing 11 for accommodating each of devices. In addition, the sensing device 10 comprises a stereo camera (visual sensor) 12, a distance image data generating device 13, a SLAM processing device (data processor) 14, a storage unit 20, and a communicator 21, as shown in FIG. 2.

The housing 11 is formed in a hollow spherical shape. A support case 25 is disposed in the center of internal space of the housing 11. The support case 25 is fixed to the inner wall of the housing 11 via a plurality of rod-shaped support shafts 26. In the support case 25, the stereo camera 12, the distance image data generating device 13, the SLAM processing device 14, the storage unit 20, and the communicator 21 are located. In the support case 25, a rechargeable battery (not shown) for providing power to the components described above is located.

The housing 11 is formed with an opening 11a of an appropriate size. Through the opening 11a, the stereo camera 12 housed inside can image outside.

Although not shown, it is preferable that a member (e.g., rubber, etc.) capable of absorbing impacts is attached to the surface of the housing 11. As a result, even if the sensing device 10 collides with something external as a result of being thrown as described below, the impacts on the internal devices can be reduced and damage to the external environment can be prevented. The entirety of the housing 11 may comprise a material capable of absorbing vibrations.

The stereo camera 12 comprises a pair of imaging devices (image sensor) placed apart by a suitable distance from each other. Each of the imaging devices can be configured, for example, as a CCD (Charge Coupled Device). The two imaging devices operate in synchronization with each other, thus generating a pair of image data by imaging external environment simultaneously. In this embodiment, the pair of image data (stereo image data) correspond to environmental information. In order to increase the speed of the stereo camera 12, for example, image data acquired by the CCD is directly written to the RAM and stored. Therefore, the stereo camera 12 can generate image data of 500 frames or more, preferably 1000 frames or more per second.

The distance image data generating device 13 is configured as a computer capable of image processing. The distance image data generating device 13 comprises a CPU, a ROM, a RAM, and the like. The distance image data generating device 13 obtains deviations of the corresponding positions of each image (called parallax) by performing a known stereo-matching processing for a pair of image data obtained by the stereo camera 12. Parallax is inversely proportional to distance, the closer the distance to the captured object is, the greater the parallax. Based on this parallax, the distance image data generating device 13 generates a distance image data in which distance information is associated with each pixel of the image data.

The generation of the distance image data is performed in real time, each time the stereo camera 12 generates the image data. Therefore, the distance image data can be obtained at a frequency similar to that of the stereo camera 12. The distance image data generating device 13 outputs the generated distance image data to the SLAM processing device 14.

The SLAM processing device 14, similar to the distance image data generating device 13, is configured as a computer comprising a CPU, a ROM, a RAM, and the like. The SLAM processing device 14 performs SLAM (Simultaneous Localization and Mapping) processing on the distance image data input from the distance image data generating device 13. Thus, estimated information of a position and a posture of the stereo camera 12 and an external environment three-dimensional data which is an environmental map can be obtained simultaneously. The SLAM processing performed by using camera images in this manner is called Visual-SLAM. The position and the posture of the stereo camera 12 correspond to a position and a posture of the sensing device 10.

As shown in FIG. 3, the SLAM processing device 14 comprises a feature point processor 15, an environmental map generator 16, and a self-position estimator 17.

The feature point processor 15 sets appropriate feature points and acquires their movements by analyzing images of the distance image data sequentially input to the SLAM processing device 14. The feature point processor 15 outputs information of feature points and their movements to the environmental map generator 16 and the self-position estimator 17.

The feature point processor 15 comprises a feature point extractor 18 and a feature point tracker 19.

The feature point extractor 18 extracts a plurality of feature points from an image contained in the distance image data by a known method. Various methods for extracting feature points have been proposed, and various algorithms such as Harris, FAST, SIFT, SURF, for example, can be used. The feature point extractor 18 outputs information such as coordinates of the obtained feature points to the feature point tracker 19. The information output to the feature point tracker 19 may include feature amounts described with respect to the feature points.

The feature point tracker 19 tracks feature points appearing in the images by a known method among a plurality of distance image data obtained successively. Various methods for tracking feature points have been proposed, and for example, Horn-Schunk method, the Lucas-Kanade method, and the like can be used. With this processing, an optical flow which is a vector representation of the motion of feature points in the plane corresponding to the image can be obtained.

The environmental map generator 16 sequentially generates a three-dimensional map which is an environmental map (called as external environment three-dimensional data), based on data of the feature points input from the feature point processor 15. The self-position estimator 17 sequentially acquires a position and a posture of the stereo camera 12 based on tracking results of the feature points.

Hereinafter, a specific description will be given. A three-dimensional map coordinate system (world coordinate system) for creating a map is defined. In a three-dimensional space represented by the coordinate system, an initial position and an initial posture of the stereo camera 12 are given in some way. Thereafter, information of feature points based on the first distance image data is input from the feature point processor 15 to the environmental map generator 16. The information of the feature point contains coordinates representing a position of the feature point on the image and a distance to that feature point (the distance associated with coordinate in the distance image data). The environmental map generator 16 calculates the position of the feature point in the three-dimensional map coordinate system using the position and the posture of the stereo camera 12, the coordinate of the feature point in the image, and the distance associated with the coordinate. The environmental map generator 16 outputs the obtained information of the position of the feature point to storage unit 20 to be stored. This process corresponds to plotting feature point as a part of the three-dimensional map in the three-dimensional space.

Subsequently, suppose that new distance image data is obtained and the previously set tracking results of feature points and the newly set feature points are input from the feature point processor 15. The self-position estimator 17 estimates the change in the position and the posture of the stereo camera 12. The estimation is based on the tracking results of the feature points (change of a position and a distance) which are input and the position of the feature point in the three-dimensional map coordinate system. As a result, a new position and a new posture of the stereo camera 12 in the three-dimensional map coordinate system can be obtained.

Next, the environmental map generator 16 calculates the position in the three-dimensional map coordinate system of the newly set feature points based on the updated position and the updated posture of the stereo camera 12, and outputs the calculated result to the storage unit 20. As a result, new feature points can be plotted additionally in the three-dimensional space.

Thus, an update process of the three-dimensional map data by the environmental map generator 16 and an update process of the position and the posture of the stereo camera 12 by the self-position estimator 17 are alternately repeated in real time for each input of the distance image data. By the above, it is possible to generate the three-dimensional map data as a plotted point cloud.

The storage unit 20 stores the three-dimensional map data generated by the environmental map generator 16. The storage unit 20 may further store a change history of the position and the posture of the stereo camera 12 calculated by the self-position estimator 17.

The communicator 21 can communicate with an external device 50 located outside the housing 11, for example, by radio. Thus, operation of the sensing device 10 can be controlled based on a directive from outside. In addition, the sensing device 10 can output information collected by the sensing device 10 to outside, such as the three-dimensional map data stored in the storage unit 20.

Next, with reference to FIG. 4, an example of the use of the environment acquisition system 1 will be described. In the example of FIG. 4, the environment acquisition system 1 is used for operational assistance in performing work on a workpiece 32 using a robot arm 31.

In order to obtain data indicating, for example, how the surroundings of the robot arm 31 are, user holds the sensing device 10 of the environment acquisition system 1 in his hand and throws it appropriately toward the surroundings of the robot arm 31 and the workpiece 32.

The sensing device 10 does not have any transportation means, such as tires for traveling, propellers for flight, or the like. Therefore, the environment acquisition system 1 can be realized at low cost. Moreover, the behavior when the sensing device 10 is thrown is substantially the same as that of a ball used in ball games or the like. Therefore, it is more familiar to the user. Since the housing 11 is spherical shape, it can be made to be difficult to break, and in this sense, it can be handled easily by the user.

In the process until the thrown sensing device 10 falls to the floor, etc. and stands still, the imaging by the stereo camera 12, the generation of the distance image data by the distance image data generating device 13, and the generation of the three-dimensional map data by the SLAM processing device 14 are performed.

The above processes are performed in a state where the sensing device 10 is in parabolic motion or free fall. In other words, the processes are performed in a state where a posture of the housing 11 is not controlled and the housing 11 is not in contact with ground and is not mechanically restrained from outside. Therefore, an extremely flexible viewpoint can be realized. For example, if the sensing device 10 is thrown upwards, positions of feature points based on the viewpoint from a high place can be included in the three-dimensional map data. Therefore, it is possible to easily avoid the problems of blind spots and the like, which can easily occur when acquiring data at a fixed-point camera, and to enrich information quantity of the three-dimensional map data. The stereo camera 12 is configured to generate image data of 500 frames or more, preferably 1000 frames or more per second. Therefore, tracking of the feature points rarely fails even if the sensing device 10 moves or rotates at a high speed with the throw.

The user can also throw the sensing device 10, for example, while deliberately applying a spin. In this case, the stereo camera 12 moves along a parabola while its direction is variously changed. Therefore, the three-dimensional map data can be obtained about a wide range around the sensing device 10. In other words, a single stereo camera 12 can substantially provide a wide field of view as if it were equipped with multiple stereo cameras 12. Therefore, the configuration of the sensing device 10 can be simplified and the cost can be reduced.

The user may pick up the sensing device 10 after throwing it, and repeat the process of throwing it again. By throwing a variety of orbits at various locations, it is possible to obtain a wide range of the three-dimensional map data with high accuracy.

The three-dimensional map data generated by the sensing device 10 and stored in storage unit 20 is transmitted to the external device 50 shown in FIG. 3 by the communication unit 21.

The three-dimensional map data acquired by the external device 50 is utilized as appropriate for operational directive of the robot arm 31. For example, the three-dimensional map data can be used to determine a relative position and a posture of the workpiece 32 to an end effector at an end of the robot arm 31. Based on this information, directive is given to the robot arm 31. Thus, even if the accuracy of a sensor provided with the robot arm 31 itself is not good for some reason, the robot arm 31 can appropriately work on the workpiece 32. Alternatively, based on the three-dimensional map data, information of obstacles around the robot arm 31 can be generated. This information can prevent the robot arm 31 from interfering with its surroundings when it operates.

The external device 50 performs three-dimensional object recognition with respect to the acquired three-dimensional map data. Specifically, the external device 50 comprises a three-dimensional data searcher 51. The three-dimensional data searcher 51 stores a shape of a three-dimensional model given in advance and a name of the three-dimensional model in association with each other, for example in the form of a database. The three-dimensional data searcher 51 searches for a three-dimensional model from the acquired three-dimensional map data by a known method such as three-dimensional matching. The three-dimensional data searcher 51 assigns a corresponding name to the found three-dimensional shape, for example, as a label. Thus, for example, when a three-dimensional shape of a workpiece 32 is found from the three-dimensional map data, the label “workpiece” can be assigned.

By using the obtained label when the user instructs the robot arm 31 to perform operation, the complexity of the instruction can be satisfactorily avoided. In addition, the operation of the robot arm 31 can also be abstractly instructed, for example, “grip”, “transport”, and the like. As described above, it is possible to have the robot arm 31 perform work expected by the user by a simple user interface such as instruction of “grip workpiece” instead of instruction with numerical values or the like.

As described above, the environment acquisition system 1 in this embodiment comprises a housing 11, a stereo camera 12, and a SLAM processing device 14. The stereo camera 12 is accommodated in the housing 11. The stereo camera 12 can repeatedly acquire a stereo image data about environment of outside of the housing 11. The SLAM processing device 14 performs an estimation process of a position and a posture of the stereo camera 12 and a generating process of an external environment three-dimensional data. These processes are performed based on a distance image data obtained from a stereo image data acquired by the stereo camera 12. In a state where a posture of the housing 11 is not controlled and the housing 11 is not in contact with ground and is not mechanically restrained from outside, the stereo camera 12 can acquire the stereo image data.

Thereby, it is not necessary to secure a fixed installation space in advance or to fix devices in advance. Thus, the three-dimensional map data can be easily acquired. In addition, the environmental information can be acquired while throwing or dropping the housing 11. Therefore, lack of three-dimensional map data due to blind spots can be suppressed.

Further, in the environment acquisition system 1 of this embodiment, the stereo camera 12 can acquire the stereo image data in free fall condition of the housing 11.

Thereby, it can be used simply, for example, by simply throwing to any location.

Further, in the environment acquisition system 1 of the present embodiment, the outer shape of the housing 11 is spherical.

Thereby, throwing by human hand or the like is facilitated. In addition, because it is spherical shape, strength can be secured, and because it rotates easily, the three-dimensional map data of a wide range can be obtained.

Further, in the environment acquisition system 1 of the present embodiment, the camera acquires the stereo image data.

The camera is cheaper than, for example, the LIDAR described below. Therefore, the cost can be effectively reduced.

Further, in the environment acquisition system 1 of the present embodiment, the SLAM processing device 14 is accommodated in the housing 11. The acquisition of the stereo image data by the stereo camera 12 and the processes by the SLAM processing device 14 are performed in real time.

Thereby, the external environment three-dimensional data is acquired by real time. Thus, it is suitable for a case where immediacy is required.

Further, the environment acquisition system 1 of the present embodiment comprises a three-dimensional data searcher 51 which searches for a pre-registered three-dimensional data from the three-dimensional map data.

Thereby, for example, by detecting the object to be operated by the robot from the external environment three-dimensional data, the user interface for teaching the operation of the robot can be simplified. It is also possible, for example, to automatically detect abnormal situations appearing in the external environment three-dimensional data.

Further, in the present embodiment, the external environment is acquired by a method comprising the following an environmental information acquisition step and a data processing step. In the environmental information acquisition step, the sensing device 10 is used to cause the stereo camera 12 to acquire a stereo image data in a state where a posture of the housing 11 is not controlled and the housing 11 is not mechanically restrained from outside. In the data processing step, estimating a position and a posture of the stereo camera 12 and generating a three-dimensional map data are performed based on a distance image data obtained from the stereo image data acquired by the environmental information acquisition step.

Thereby, it is not necessary to secure a fixed installation space in advance or to fix devices in advance. Thus, the three-dimensional map data can be easily acquired. In addition, the environmental information can be obtained while throwing or dropping the housing 11. Therefore, lack of three-dimensional map data due to blind spots can be suppressed.

Although the preferred embodiments of the present invention have been described above, the configurations described above may be modified as follows, for example. The same description may be omitted.

The SLAM processing device 14 may be provided in the external device 50 instead of the sensing device 10, and external device 50 may be modified to acquire the distance image data from the sensing device 10 by radio communication and perform Visual-SLAM processing. In addition, the distance image data generating device 13 may be provided in the external device 50, and the external device 50 may be modified to acquire the stereo image data from the sensing device 10 by radio communication and to perform the generation process of the distance image data and the Visual-SLAM processing.

If the distance image data generating device 13 and the SLAM processing device 14, etc. are provided in the external device 50, the sensing device 10 can be reduced in weight, making it easier to handle. It is also possible to make sensing device 10 less fragile against impacts from outside.

On the other hand, as in the above embodiment, if the stereo camera 12, the distance image data generating device 13, and the SLAM processing device 14 are provided on the sensing device 10 side, the stereo image data, the distance image data, etc. can be input and output at high speed, thus real time processing is facilitated. In other words, even when the high-speed camera as described above is used as the stereo camera 12, the distance image data generating device 13 and the SLAM processing device 14 can be operated in real time to generate the three-dimensional map data in real time processing.

The environment acquisition system 1 may comprise a rotation drive unit which rotates the stereo camera 12 with respect to the housing 11. The rotation drive unit can be configured, for example, as an electric motor which rotates the support case 25 relative to the support shaft 26. The housing 11 is provided with an annular transparent member, for example, to face the rotational locus of a lens of the stereo camera 12 so that the stereo camera 12 can image outside while rotating.

In this case, the stereo image data can be obtained while the stereo camera 12 is forcibly rotated. Therefore, even if the movement trajectory from throwing the sensing device 10 to landing on the floor to stand still is short, a wide range of the three-dimensional map data can be obtained.

In the above embodiment, the environment acquisition system 1 is used in a state where the system is separate from the robot arm 31 or the like. However, the environment acquisition system 1 can be used by directly attaching the housing 11 to the robot arm 31 or the like.

Instead of spherical shape, the housing 11 may be configured in a cubic or rectangular shape, for example. The shape of opening 11a is not particularly limited, and may be, for example, a long pore shape. The opening Ila may be changed to a transparent window. The housing 11 may be a transparent member in its entirety.

As the visual sensor, instead of the stereo camera 12, a monocular camera may be used. In this case, the SLAM processing device 14 may perform a known monocular Visual-SLAM processing. Instead of the stereo camera 12, a known configuration in which a monocular camera and a gyro sensor are combined may be used to acquire parallax information for SLAM technologies.

The monocular camera may be rotated forcibly by the above the rotation drive unit, and the rotational direction and angular velocity of the monocular camera are measured sequentially by an appropriate measurement sensor (for example, an encoder). In this way, parallax information can be obtained and used for SLAM technologies.

As the visual sensor, a LIDAR (Laser Imaging Detection and Ranging) capable of three-dimensional measurement may be used instead of the stereo camera 12. In this case, the three-dimensional position of the object can be measured more accurately than when the stereo camera 12 is used. In addition, by using a laser, it is possible to perform scanning in which the effect of outside factors such as brightness is suppressed.

When a three-dimensional LIDAR is used, the three-dimensional point cloud data output by the three-dimensional LIDAR corresponds to the environmental information. The distance image data generating device 13 is omitted and the three-dimensional point cloud data is input to the SLAM processing device 14. In the SLAM processing device 14, the feature point processor 15 is omitted. The three-dimensional point cloud data is output to the environmental map generator 16 as part of the three-dimensional map data. Next, when the three-dimensional point cloud data is input, the point cloud is tracked and processed by known algorithms such as ICP or the like, and the information of the movement of the point cloud is output to the self-position estimator 17. The self-position estimator 17 estimates the position and the posture of the three-dimensional LIDAR based on the movement of the three-dimensional point cloud. Thus, the SLAM processing can be realized.

In order to improve the accuracy of self-position estimation by the self-position estimator 17, the sensing device 10 may be equipped with an IMU (Inertial Measuring Units) capable of measuring acceleration and angular velocity.

The three-dimensional data searcher 51 may be provided in the sensing device 10 instead of the external device 50. By recognizing the three-dimensional object on the sensing device 10 side, it is easy to utilize the recognized results quickly (almost in real time).

The sensing device 10 can also be used by attaching it to an item (e.g., a helmet) worn by a field worker via a suitable fixing jig. As a result, the worker can work not only with his/her own eyes but also with the current position information and the three-dimensional map data acquired by the SLAM processing. It is also easy to ensure traceability of the routes traveled by the worker for the work. It is also conceivable that the worker's current position and the three-dimensional map data are sent to a supervisor's display device in real time, and the supervisor look at it and give instructions to the worker. For the acquired three-dimensional map data, it is preferable to perform the three-dimensional object recognition, as in the above embodiment. As a result, it is easy to detect a foreign object that is different from a previously registered object, to detect an abnormal state (e.g., breakage or the like) of the object, or to understand a position of the object to be maintained. In this way, the work efficiency can be improved.

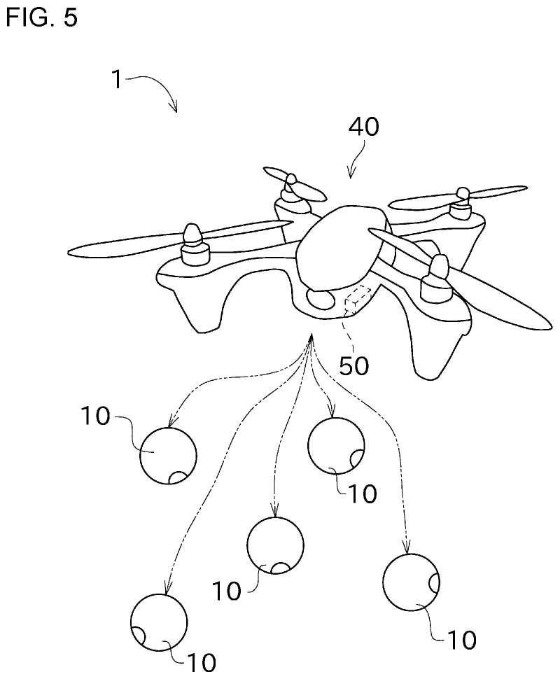

As shown in FIG. 5, a plurality of sensing devices 10 may also be set on a flying object 40, such as a drone, and used. The flying object 40 throws the sensing devices 10 from the air at once toward the area where it is desired to acquire the three-dimensional map data. As a result, each of the sensing devices 10 acquires the three-dimensional map data. The external device 50 attached to the flying object 40 collects the three-dimensional map data via radio communication from each of the sensing devices 10 and integrates into one. As a result, a wide range of three-dimensional map data can be obtained in a short time.

### DESCRIPTION OF THE REFERENCE NUMERALS

1 environment acquisition system

10 sensing device

11 housing

12 stereo camera (visual sensor)

14 SLAM processing device (data processor)

1. An environment acquisition system comprising:
a housing;
a visual sensor accommodated in the housing and being able to repeatedly acquire environmental information about environment of outside of the housing; and
a data processor performing an estimation process of a position and a posture of the visual sensor and a generation process of an external environment three-dimensional data based on the environmental information acquired by the visual sensor or information obtained from the environmental information,
wherein the visual sensor can acquire the environmental information in a state where a posture of the housing is not controlled and the housing is not in contact with ground and is not mechanically restrained from outside.

2. The environment acquisition system according to claim 1, wherein the visual sensor can acquire the environmental information in free fall condition of the housing.

3. The environment acquisition system according to claim 1, wherein
an outer shape of the housing is spherical.

4. The environment acquisition system according to claim 1, wherein
the visual sensor is a camera.

5. The environment acquisition system according to claim 1, wherein
the data processor is accommodated in the housing, and
the acquisition of the environmental information by the visual sensor and the processes by the data processor are performed in real time.

6. The environment acquisition system according to claim 1, wherein
the data processor is located outside of the housing, and
the data processor obtains the environmental information acquired by the visual sensor via communication and performs the processes with respect to the environmental information.

7. The environment acquisition system according to claim 1, comprising
a rotation drive unit which rotates the visual sensor with respect to the housing.

8. The environment acquisition system according to claim 1 comprising
a three-dimensional data searcher which searches for a pre-registered three-dimensional data from the external environment three-dimensional data.

9. An environment acquisition method comprising:
an environmental information acquisition step using a sensing device comprising:
a housing; and
a visual sensor accommodated in the housing and being able to repeatedly acquire environmental information about environment of outside of the housing,
causing the visual sensor to acquire the environmental information in a state where a posture of the housing is not controlled and the housing is not in contact with ground and is not mechanically restrained from outside; and
a data processing step estimating a position and a posture of the visual sensor and generating an external environment three-dimensional data based on the environmental information acquired in the environmental information acquisition step or information obtained from the environmental information.
